(19) United States
(12) Patent Application Publication
(10) Pub. No.: US 2017/0021571 A1
(43) Pub. Date: Jan. 26, 2017

(54) Apparatus and Method for Manufacture of a 3D-Modeled Object

(71) Applicant: Konica Minolta, Inc., Tokyo (JP)

(72) Inventors: Masayasu HAGA, Toyokawa-shi (JP); Eiji TABATA, Ibaraki-shi (JP); Toshiya NATSUHARA, Takarazuka-shi (JP); Tomoo IZUMI, Toyonaka-shi, Osaka (JP)

(73) Assignee: Konica Minolta, Inc., Tokyo (JP)

(21) Appl. No.: 15/124,615

(22) PCT Filed: Jan. 19, 2015
(86) PCT No.: PCT/JP2015/051198

§ 371 Date: Sep. 8, 2016

(30) Foreign Application Priority Data
Mar. 11, 2014 (JP) 2014-047862

(51) Int. Cl. B29C 67/00; G05B 19/4099

(52) U.S. Cl. CPC B29C 67/0088; G05B 19/4099; B33Y 10/00

(57) ABSTRACT

The manufacturing apparatus (1) for three-dimensional moldings is provided with a molding block (20), a tag-supplying block (30) and a control unit (12). The molding block (20) is a molding device for molding a three-dimensional object by successively layering molding material layer by layer. The tag-supplying block (30) is a tag-supplying device for supplying a wireless communication tag to a specified position. The control unit (12) causes the tag-supplying block (30) to supply the wireless communication tag to the specified position of the molding material during layering of the molding material by the molding block (20) so that the wireless communication tag is embedded inside the three-dimensional molding that is obtained by layering the molding material.

### TECHNICAL FIELD

The present invention relates to an apparatus and a method for manufacture of a 3d-modeled object that is provided with a wireless communication tag.

### BACKGROUND ART

Today, 3D (three-dimensional) printers are commercially available from different manufacturers, and 3D modeling has been becoming increasingly common. It is expected that, in the near future, mass-manufacturing of standardized products will shift to manufacturing of a wide variety of products in small quantities to suit consumers' preferences.

On the other hand, near-field wireless communication tags, such as NFC (near-field communication) tags and RFID (radio-frequency identification) tags, and near-field wireless communication functions, such as iBeacon, are increasingly in practical use in various applications including automatic recognition. For example, a near-field wireless communication tag can be affixed to, or previously embedded in, an object; it is then possible to automatically recognize the object by wireless communication with a terminal such as a smartphone.

Conventionally, a wireless communication tag can be incorporated in an object, for example, in one of the following manners. According to Patent Document 1, a strip of adhesive tape, called wireless communication tag tape, in which a wireless communication tag is arranged on a base with an adhesive surface is prepared. This tape is affixed to an appropriate place on an object so that the wireless communication tag is located on the outside of the object.

According to Patent Documents 2 and 3, a wireless communication tag is embedded inside an object (resin) by injection molding. According to Patent Document 4, a wireless communication tag is placed between two sheet-form molded members, which are then bonded together, thereby to manufacture a 3D-modeled object that incorporates a wireless communication tag.

According to Non-Patent Document 1, a ring and a base of a finger ring are fabricated on a 3D printer, and a wireless communication tag is arranged on the base and is then covered with a simple cover, thereby to manufacture a finger ring that incorporates a wireless communication tag. This ring was developed with the funds raised by Kickstarter, a US-based private non-profit cloud-funding enterprise, and is marketed under the trade name “Sesame Ring”.

### LIST OF CITATIONS

### Patent Literature

Patent Document 1: Japanese Utility Model Registered No. 3128557 (claim 1, paragraph [0014], FIG. 8, etc.)

Patent Document 2: Japanese Patent Application Published No. H08-276458 (claims 1 and 2, paragraphs [0013]-[0015], FIGS. 1 and 4, etc.)

Patent Document 3: Japanese Patent Application Published No. H11-348073 (claims 1 and 6, paragraphs [0007]-[0008], FIG. 1, etc.)

Patent Document 4: Japanese Patent Application Published No. 2002-007989 (claim 6, paragraph [0044], FIGS. 5(a) and (b), etc.)

### Non-Patent Literature

Non-Patent Document 1: kickstarter, “Sesame Ring—Where will it take you? By Ring Theory”, [on line], [as of Jan. 27, 2014], on the Internet, <URL: http://www.kickstarter.com/projects/1066401427/sesame-ring-where-will-it-take-you>

### SUMMARY OF THE INVENTION

### Technical Problem

Inconveniently, however, with any of Patent Documents 1 to 4 and Non-Patent Document 1, a third party can recognize the presence of the wireless communication tag that is affixed to, or incorporated in, the object; the third party can pluck out the wireless communication tag.

Specifically, the wireless communication tag tape according to Patent Document 1 is advantageous in permitting a wireless communication tag to be arranged on the outside of an object with any shape by being affixed to the object. However, a third party can definitely recognize the affixed wireless communication tag from the exterior appearance; thus, the third party may pluck out (peel off) the wireless communication tag with ease.

According to Patent Document 2 or 3, a wireless communication tag is embedded in an object with an arbitrary shape by injection molding; this leaves, on the outside of the product, a parting line, that is, the mark of the seam between an upper and a lower mold. The parting line suggests the arrangement of the wireless communication tag inside the product. A third party can thus recognize the presence of the wireless communication tag inside; the third party may then break the product along the parting line and pluck out the wireless communication tag inside.

According to Patent Document 4, the seam at which the two molded members are bonded together leaves a streak mark. The streak mark suggests the arrangement of the wireless communication tag inside. A third party can thus recognize the presence of the wireless communication tag inside. Thus, as with injection molding, the third party may break the modeled object along the seam line and pluck out the wireless communication tag inside.

According to Non-Patent Document 1, a finger ring is manufactured on a 3D printer; this is advantageous in permitting a wireless communication tag to be arranged in a finger ring (modeled object) with a desired design. However, considering that the wireless communication tag is arranged after modeling and is then covered, actually only part of the 3D-modeled object is manufactured on the 3D printer. Thus, this technique suffers from problems that are intrinsically similar to those with the bonding-together according to Patent Document 4.

Devised to address the inconveniences mentioned above, the present invention aims to provide such an apparatus and a method for manufacturing a 3D-modeled object that permit a wireless communication tag to be embedded inside the 3D-modeled object such that it is difficult for a third party to recognize the presence of the wireless communication tag inside and that can thereby reduce the likelihood of the wireless communication tag inside being plucked out by a third party.

### Means for Solving the Problem

According to one aspect of the present invention, an apparatus for manufacturing a 3D-modeled object includes: a modeler that models a 3D object by stacking layers of a modeling material one over another; a tag feeder that feeds a wireless communication tag to a predetermined position; and a controller that controls the stacking of the modeling material by the modeler and the feeding of the wireless communication tag by the tag feeder. Here, the controller makes the tag feeder feed the wireless communication tag to the predetermined position in the modeling material in the middle of the stacking of the modeling material by the modeler such that the wireless communication tag is embedded inside the 3D-modeled object formed of the stacked layers of the modeling material.

According to another aspect of the present invention, a method for manufacturing a 3D-modeled object includes: a process (a) of, after starting the stacking of layers of a modeling material, suspending the stacking for a while to feed a wireless communication tag to a predetermined position in the modeling material; and a process (b) of, after feeding the wireless communication tag, restarting the stacking of the modeling material to continue to stack the modeling material until the modeling of the 3D-modeled object is completed so that the wireless communication tag is embedded inside the 3D-modeled object.

### Advantageous Effects of the Invention

With an apparatus and a method for manufacturing a 3D-modeled object as described above, it is possible to embed a wireless communication tag inside the 3D-modeled object such that it is difficult for a third party to recognize the presence of the wireless communication tag inside, and it is thus possible to reduce the likelihood of the wireless communication tag inside being plucked out by a third party.

### BRIEF DESCRIPTION OF DRAWINGS

FIG. 1 is a block diagram showing an outline of the configuration of a 3D-modeled object manufacturing apparatus according to an embodiment of the present invention;

FIG. 2 is a sectional view schematically showing part of the manufacturing apparatus;

FIG. 3 is a flow chart showing the steps for manufacturing the 3D-modeled object;

FIG. 4 is an illustrative diagram schematically showing layer-by-layer data for modeling material, for the manufacture of a four-layer 3D-modeled object;

FIG. 5 is a sectional view showing the steps for modeling the 3D-modeled object; and

FIG. 6 is an illustrative diagram schematically showing the timing with which to feed a wireless communication tag.

### DESCRIPTION OF EMBODIMENTS

An embodiment of the present invention will be described below with reference to the accompanying drawings.

### Three-Dimensional Modeled Object Manufacturing Apparatus

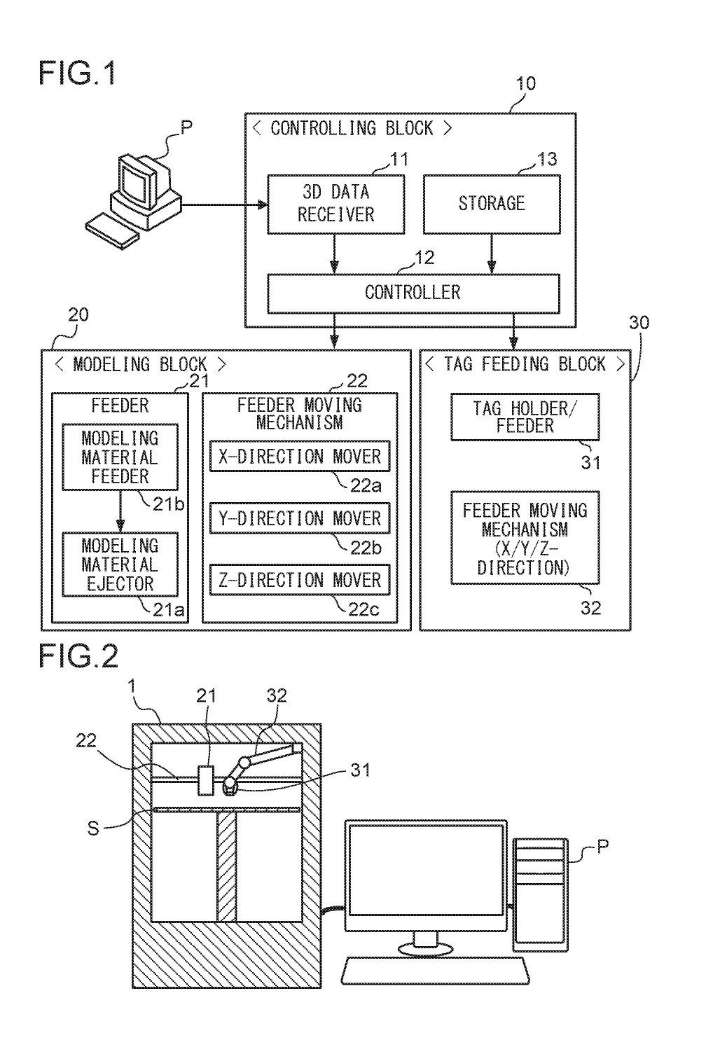

FIG. 1 is a block diagram showing an outline of the configuration of a three-dimensional (3D) modeled object manufacturing apparatus 1 according to one embodiment of the present invention. FIG. 2 is a sectional view schematically showing part of the manufacturing apparatus 1. The manufacturing apparatus 1 is an apparatus that models a 3D object (manufactures a 3D-modeled object) by an additive manufacturing process. In the present specification, of all 3D objects, those manufactured by modeling in particular are referred to as 3D-modeled objects.

Examples of the above-mentioned additive manufacturing process include a fused deposition modeling (FDM) process, an ink-jet process, an ink-jet binder process, a stereo-lithography (SL) process, and a selective laser sintering (SLS) process. Any of these processes can be used to manufacture a 3D modeled object according to the embodiment, though with varying suitability depending on the size and type of the 3D-modeled object to be manufactured. The embodiment described below deals with an example where an ink-jet process is used as an additive manufacturing process

The 3D-modeled object manufacturing apparatus 1 includes a controlling block 10, a modeling block 20, a tag feeding block 30, etc. The manufacturing apparatus 1 may further include, as necessary, a removing block (unillustrated) for removing excess modeling material, a wireless communication tag placement hole forming block (unillustrated) for forming, in an object being modeled, a hole in which to place a wireless communication tag, etc. Each block will now be described in detail.

### Controlling Block

The controlling block 10 includes a 3D data receiver 11, a controller 12, a storage 13, etc. The storage 13 comprises memory for storing shape data for a plurality of wireless communication tags. The provision of the storage 13 is optional.

The 3D data receiver 11 is a frontend that receives three-dimensional shape data (3D data) of a modeling target (would-be 3D-modeled object). The 3D data receiver 11 may be configured so as to acquire 3D data of a 3D-modeled object from an external computer P or the like across a communication line, or may be configured as an operated device, such as a keyboard, that directly accepts entry of 3D data of a 3D-modeled object. The 3D data received by the 3D data receiver 11 is transferred to the controller 12.

The controller 12 includes a data processor such as a CPU (central processing unit); based on 3D data transferred from the 3D data receiver 11, it creates (constructs) layer-by-layer data for three-dimensional modeling using modelling material. Also, based on shape data for a wireless communication tag that is stored in the storage 13, the controller 12 calculates a position (embedding position) at which to place the wireless communication tag inside the 3D-modeled object; it then calculates the data of an interior structure of the 3D-modeled object that permits the wireless communication tag to be placed at the calculated placement position, merges the above-mentioned layer-by-layer data with the data of the interior structure, and thereby re-constructs the layer-by-layer data to be used in modeling (hereinafter referred to also as slice data). The controller 12 also calculates the timing with which to suspend the stacking of modeling material to place the wireless communication tag.

Overall, the controller 12 controls the operation of the entire apparatus, in such aspects as the stacking of modeling material by the modeling block 20, the feeding of a wireless communication tag by the tag feeding block 30, to name a few.

The 3D data receiver 11 and the controller 12 may be implemented as hardware that operates as described above, or may be implemented as control programs that, when run, function as a 3D data receiver and a controller.

### Modeling Block

The modeling block 20 is a modeler that models a 3D object by stacking layers of modeling material one over another. The modeling block 20 includes a feeder 21 that feeds modeling material (e.g., ink) to a predetermined position and a feeder moving mechanism 22 that moves the feeder 21 so that modeling material is fed to the target position.

The feeder 21 includes a modeling material ejector 21a and a modeling material feeder 21b. According to the slice data acquired from the controlling block 10, the modeling material ejector 21a ejects modeling material onto a modeling stage S, to the position determined by the feeder moving mechanism 22, with desired timing. In a case where ink is used as modeling material, the modeling material ejector 21a is configured as an ink-jet head (ink ejector) that ejects ink. The ink ejected onto the modeling stage S is cured by being irradiated with ultraviolet radiation from an unillustrated light source. The modeling material feeder 21b feeds modeling material, which is stored in an unillustrated reservoir, to the modeling material ejector 21a. In a case where ink is used as modeling material, the modeling material feeder 21b is configured as a tube (ink feeder) through which the ink is fed to the ink-jet head.

The feeder moving mechanism 22 includes an X-direction mover 22a, a Y-direction mover 22b, and a Z-direction mover 22c. Based on movement control information acquired from the controlling block 10, the X-, Y-, and Z-direction movers 22a, 22b, and 22c drive an unillustrated driving mechanism to move the feeder 21 in different directions three-dimensionally, specifically in X, Y, and Z directions which are perpendicular to each other.

The manufacturing apparatus 1 may include one modeling material ejector 21a and one modeling material feeder 21b, or may include a plurality of each.

The above-described configuration of the modeling block 20 is one for a case where an ink-jet process is used as an additive manufacturing process, and allows for appropriate modifications depending on the type of the additive manufacturing process used. For example, in a case where stereo-lithography is used as an additive manufacturing process, the modeling block 20 can be configured to include a container in which to accommodate ultraviolet-curing resin as modeling material, a light source that radiates ultraviolet radiation to the ultraviolet-curing resin placed on a base plate, an elevating mechanism that lowers the base plate each time the curing of a layer (the topmost layer) by irradiation with ultraviolet radiation is completed, etc. In any case (no matter what additive manufacturing process is used), the modeling block 20 can be configured to model a 3D object by stacking layers of modeling material one over another.

### Tag Feeding Block

The tag feeding block 30 feeds a wireless communication tag to a predetermined position, and includes a tag holder/feeder 31 and a feeder moving mechanism 32.

As the wireless communication tag, it is possible to use, for example, a UHF (ultra-high frequency) super-compact package tag (sized 2.5 mm by 2.5 mm, with a thickness of 0.3 mm, manufactured by Hitachi Chemical Co., Ltd.). Any other wireless communication tag can be used so long as it is capable of wireless communication and can be accommodated inside a 3D-modeled object; for example, it is possible to use any other type of tag, such as an RFID or NFC tag, or one with any other wireless communication function such as iBeacon.

The tag holder/feeder 31 corresponds to a holder at the distal end of a robot arm; it snatches a wireless communication tag from an unillustrated wireless communication tag stocker and releases it at a desired position. Also, according to a tag placement position (embedding position) and tag placement timing (feed timing) acquired from the controlling block 10, the tag holder/feeder 31 places a wireless communication tag inside the object that is being modeled, at the position determined by the feeder moving mechanism 32, with the desired time. The feeder moving mechanism 32 corresponds to a robot arm; it serves to make the tag holder/feeder 31 at the distal end of the arm move in each of the X, Y, and Z directions which are perpendicular to each other.

### 3D-Modeled Object Manufacturing Method

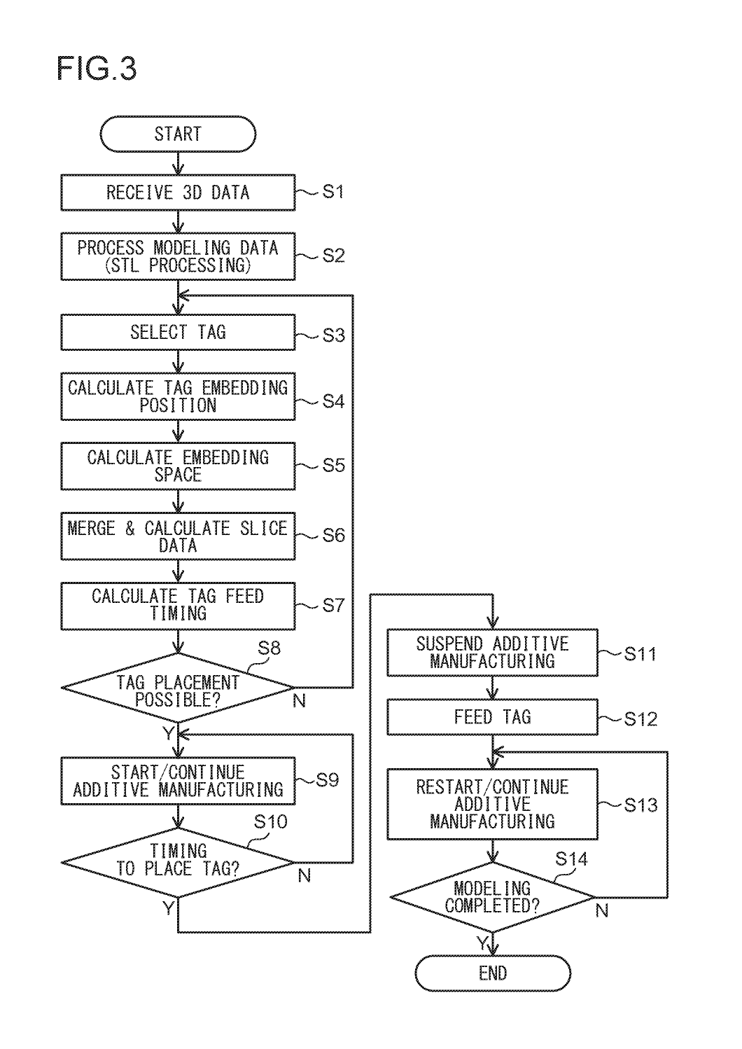

Next, a description will be given of a 3D-modeled object manufacturing method that employs the manufacturing apparatus 1 described above. FIG. 3 is a flow chart showing the steps for manufacturing a 3D-modeled object. In FIG. 3, the individual steps, which will be referred to as Steps 1, 2, . . . below, are identified as S1, S2, . . .

(Step 1)—Process (I)

The 3D data of a 3D-modeled object as a modeling target is transferred from a computer P to the 3D data receiver 11.

(Step 2)

Based on the 3D data received at Step 1, the controller 12 creates (two-dimensional) data for each layer of modeling material to be used to model a 3D-modeled object three-dimensionally. This is referred to as modeling data processing or STL (standard triangulated language) processing.

(Step 3)

Based on the acquired 3D data, the controller 12 selects (decides) a wireless communication tag that can be embedded in the 3D-modeled object. Here, if shape data for a plurality of wireless communication tags is stored in the storage 13, the controller 12 can select, referring to the data in the storage 13, an appropriate wireless communication tag that suits the shape of the 3D-modeled object. At Step 3, if the 3D-modeled object is evidently so shaped as to be sufficiently large compared with a tag, one tag (with the same shape all the time) may always be selected.

(Step 4)—Process (c)

For the wireless communication tag selected at Step 3, the controller 12 calculates a position (placement position) at which to embed it inside the 3D-modeled object. Specifically, based on the above-mentioned 3D data and the shape data for the selected wireless communication tag, the controller 12 calculates an embedding position at which the wireless communication tag does not protrude out of the 3D-modeled object. Here, as the shape data for the wireless communication tag, data stored in the storage 13 may be used, or predetermined values (in particular in a case where one type of tag is involved) may be used.

(Steps 5 and 6)—Process (d)

The controller 12 creates data of a space (interior structure) that is necessary to embed the wireless communication tag inside the 3D-modeled object. That is, the controller 12 creates (three-dimensional) data of a space corresponding to the three-dimensional shape of the wireless communication tag such that the wireless communication tag can be placed at the embedding position calculated at Step 4. Here, the shape (size) of the embedding space may be identical with that of the wireless communication tag, or may be slightly larger than that of the wireless communication tag. Then, the controller 12 merges the above-mentioned layer-by-layer data for modeling material with the data of the embedding space to create (re-construct) the layer-by-layer data to be used in modeling.

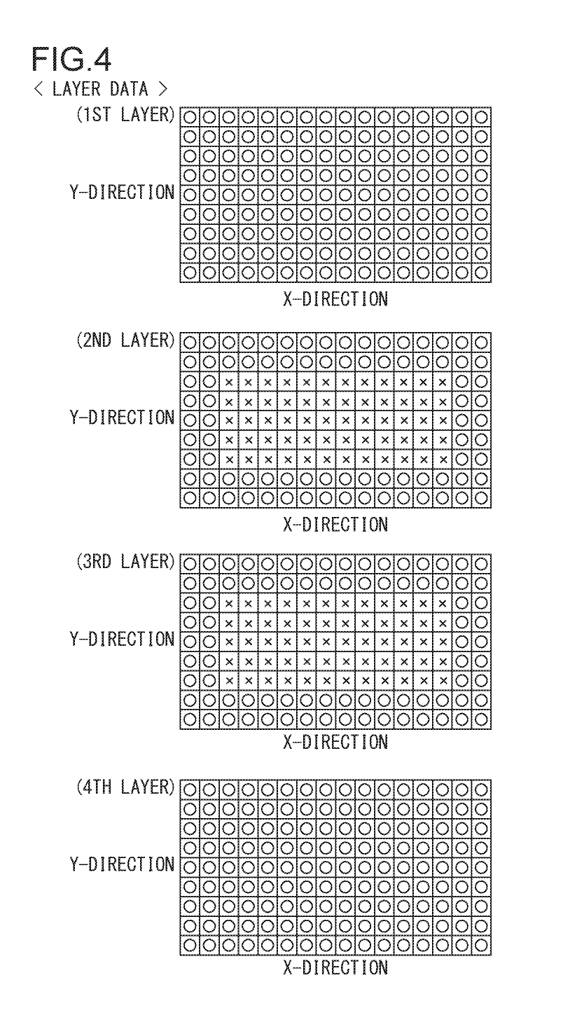

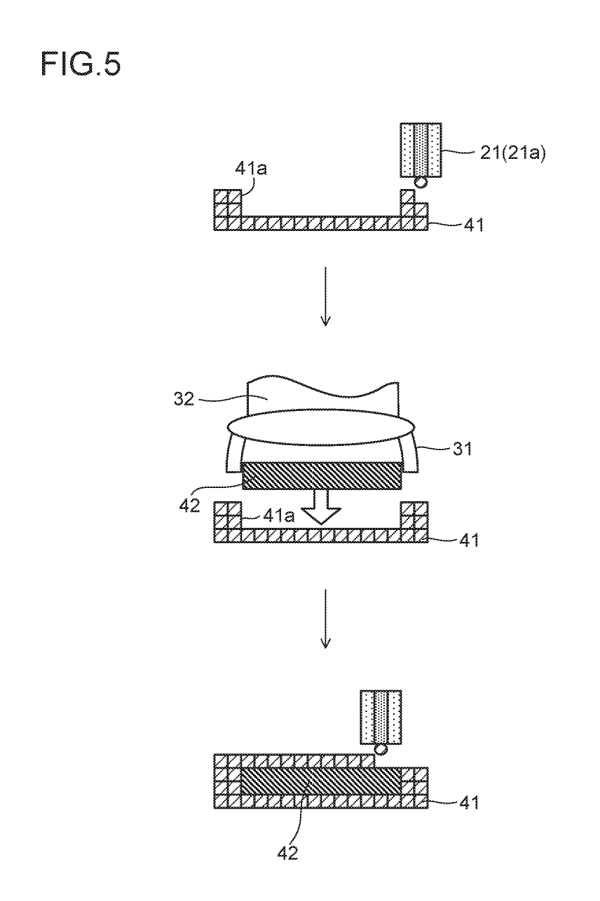

FIG. 4 schematically shows an example of reconstructed layer-by-layer data for modeling material (data of layers each extending over the XY plane) in a case where a 3D-modeled object in the shape of a rectangular parallelepiped is manufactured by stacking four layers of modeling material one over another in the Z direction. In FIG. 4, circles indicate the segments of data where modeling material needs to be ejected, and crosses indicate the segments of data where modeling material does not need to be ejected. The data of the above-mentioned space corresponds to the segments of data indicated by crosses. At Step 6, the controller 12 creates such layer-by-layer data (slice data).

(Step 7)—Process (e)

Based on the layer-by-layer data obtained at Step 6, the controller 12 determines the timing with which to feed the wireless communication tag to the predetermined position. Specifically, based on the layer-by-layer data, the controller 12 calculates the timing with which to suspend modeling (the stacking of modeling material) to place the wireless communication tag. For example, based on the layer-by-layer data shown in FIG. 4, the controller 12 can take the time point at which the stacking of the third layer is completed as the timing with which to feed the wireless communication tag. The just-mentioned feed timing corresponds to the time point at which a recess with a depth corresponding to the thickness of the wireless communication tag is formed by stacking modeling material based on the layer-by-layer data as will be described later.

(Step 8)

The controller 12 checks whether or not the wireless communication tag can be embedded inside the 3D-modeled object successfully by feeding the wireless communication tag with the feed timing determined at Step 7. For example, if it is found that, the wireless communication tag cannot be embedded inside the 3D-modeled object successfully for some reason such as because the timing with which to feed the wireless communication tag comes after the completion of the modeling of the 3D-modeled object (after the completion of the stacking of the topmost layer), a return is made to Step 3 so that the procedure will be redone starting with the selection of a tag. If, at Step 8, it is found that the wireless communication tag can be embedded inside the 3D-modeled object, an advance is directly made to Step 9. Step 8 is provided just in case, and can be omitted.

(Steps 9 to 12)—Process (a)

FIG. 5 is a sectional view showing the steps of modeling a 3D-modeled object. As shown in a top part of FIG. 5, based on the slice data created at Step 6, the controller 12 starts the stacking of modeling material 41 by the modeling block 20 (S9), and continues the stacking of the modeling material 41 based on the layer-by-layer data until the feed timing of the wireless communication tag 42 as determined at Step 7. The modeling here proceeds such that, as the modeling material 41 is stacked, the embedding space determined at Step 5 is formed.

Thereafter, as shown in a middle part of FIG. 5, when the feed timing of the wireless communication tag 42 arrives (S10), that is, when the stacking of the third layer of the modeling material 41 is completed and a recess 41a with a depth corresponding to the thickness of the wireless communication tag 42 has been formed, the controller 12 suspends the stacking of the modeling material 41 for a while (S11). The controller 12 then makes the tag feeding block 30 feed the wireless communication tag 42 to the predetermined position in the modeling material 41, that is, into the recess 41a, which serves as a placement space for the wireless communication tag 42 (S12). It is here assumed that the recess 41a is so shaped as to have an opening through which the wireless communication tag 42 can be embedded there (it is not a closed space).

(Steps 13 and 14)—Process (b)

As shown in a bottom part of FIG. 5, after the feeding of the wireless communication tag 42, the controller 12 restarts the stacking of the modeling material 41 based on the layer-by-layer data (S13), and continues the stacking of the modeling material 41 until the modeling of the 3D-modeled object is completed. In this way, the wireless communication tag 42 is embedded inside the 3D-modeled object, at the embedding position calculated at Step 4.

As described above, the controller 12 makes the tag feeding block 30 feed the wireless communication tag 42 to a predetermined position in the modeling material 41 in the middle of the stacking of the modeling material 41 by the modeling block 20 so that the wireless communication tag 42 is embedded inside the 3D-modeled object which is formed of stacked layers of modeling material 41. Since modeling proceeds by an additive manufacturing process which involves the stacking of layers of the modeling material 41, no streak noise, such as parting lines and seam lines, appears on the manufactured 3D-modeled object as when modeling proceeds by injection molding or by the putting-together of molded members. Thus, once the wireless communication tag 42 is embedded inside the 3D-modeled object, it is difficult for a third party to recognize the presence of the wireless communication tag 42. This helps reduce the likelihood of a third party plucking out the wireless communication tag 42 inside the 3D-modeled object.

With a conventional method involving the affixing of tape incorporating a wireless communication tag to the outside of a 3D-modeled object, the affixed tape or wireless communication tag may spoil the exterior appearance of the 3D-modeled object, and the tape may peel off as time passes or as the 3D-modeled object is used. By contrast, according to the embodiment, since the wireless communication tag is embedded inside the 3D-modeled object, no such inconveniences as just mentioned arise. In a case where modeling proceeds by injection molding, a mold needs to be prepared whenever necessary. By contrast, in a case where modeling proceeds by an additive manufacturing process as in the embodiment, no mold is needed, and this makes it easier to manufacture a 3D-modeled object than by injection molding.

In the embodiment, the embedding position of the wireless communication tag 42 is calculated based on the 3D data of the 3D-modeled object and the shape data of the wireless communication tag 42. This makes it possible to determine an embedding position at which the wireless communication tag 42 does not protrude out of the 3D-modeled object. Thus, by feeding the wireless communication tag 42 in the middle of stacking layers of the modeling material 41 such that the wireless communication tag 42 is embedded in such an embedding position, it is possible to embed the wireless communication tag 42 appropriately inside the 3D-modeled object.

In the embodiment, based on the 3D data of the 3D-modeled object, a wireless communication tag 42 with a shape that can be embedded is selected referring to the storage 13, and for the selected wireless communication tag 42, the embedding position is calculated. Thus, it is possible to reliably embed, at the embedding position inside the 3D-modeled object, the wireless communication tag 42 with a shape that suits the shape of the 3D-modeled object.

The layer-by-layer data for the modeling material 41 is created by merging the shape data of the 3D-modeled object with the data of the space in which to embed the wireless communication tag 42. Thus, by stacking layers of the modeling material 41 based on the layer-by-layer data, it is possible, while securing a space in which to embed the wireless communication tag 42 (in the example shown in FIG. 4, the recess 41a), to stack layers of the modeling material 41 elsewhere, so as to thereby manufacture the 3D-modeled object.

The wireless communication tag 42 is fed to the predetermined position in the modeling material 41 with the feed timing that is determined based on the layer-by-layer data for the modeling material 41. In particular, in the embodiment, the feed timing is the time point at which the recess 41a with a depth corresponding to the thickness of the wireless communication tag 42 is formed by stacking layers of the modeling material 41. It is thus possible to confirm that the wireless communication tag 42 has been embedded in the recess 41a.

Owing to 3D data of a 3D-modeled object being fed to the 3D data receiver 11, the controller 12 can reliably perform processes that uses the 3D data, namely the calculation of an embedding position of the wireless communication tag 42, the selection of a wireless communication tag 42 with a shape that can be embedded, and the creation of layer-by-layer data.

In the embodiment, as shown in FIG. 4, ink is used as the modeling material 41 so that layers of ink are stacked over each other; thus, the embodiment provides the above-mentioned effects in a case where a 3D-modeled object is manufactured by an ink-jet process in particular out of different additive manufacturing processes.

### Other

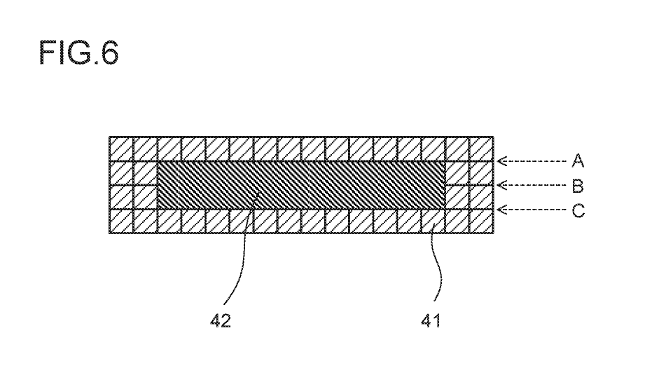

FIG. 6 schematically shows an example of the timing with which to feed the wireless communication tag 42. In the embodiment, since modeling proceeds by an additive manufacturing process, the wireless communication tag 42 can be fed to a predetermined position in the modeling material 41 with any timing so long as the wireless communication tag 42 can be embedded. The timing is thus not limited to the time point (timing A) at which the above-mentioned recess 41a is formed, that is, in the example in FIG. 5, the time point at which the ejection of the modeling material 41 for the third layer is completed. It may instead be the time point (timing B) at which the ejection of the modeling material 41 for the second layer is completed, or the time point (timing C) at which the ejection of the modeling material 41 for the first layer is completed. That is, the wireless communication tag 42 can be fed with any timing after the start until the end of the formation of the recess 41a (placement space) through the stacking of layers of the modeling material 41.

The above-described apparatus and method for manufacturing a 3D-modeled object can be expressed as follows, and provide effects as described below.

The above-described apparatus for manufacturing a 3D-modeled object includes: a modeler that models a 3D object by stacking layers of a modeling material one over another; a tag feeder that feeds a wireless communication tag to a predetermined position; and a controller that controls the stacking of the modeling material by the modeler and the feeding of the wireless communication tag by the tag feeder. Here, the controller makes the tag feeder feed the wireless communication tag to the predetermined position in the modeling material in the middle of the stacking of the modeling material by the modeler such that the wireless communication tag is embedded inside the 3D-modeled object formed of the stacked layers of the modeling material.

The modeler models the 3D object by a so-called additive manufacturing process, which involves stacking layers of the modeling material one over another. Under the control of the controller, in the middle of the stacking of the modeling material by the modeler, the tag feeder feeds the wireless communication tag to the predetermined position in the stacked modeling material. In this way, the wireless communication tag is embedded inside the 3D-modeled object, which as a whole is formed by stacking the modeling material.

Since modeling proceeds by an additive manufacturing process, no streak noise, such as parting lines and seam lines, appears on the manufactured 3D-modeled object as when modeling proceeds by injection molding or by the putting-together of molded members. Thus, once the wireless communication tag is embedded inside the 3D-modeled object, it is difficult for a third party to recognize the presence of the wireless communication tag inside.

That is, with the above configuration, it is possible to embed a wireless communication tag inside a 3D-modeled object in such a manner that it is difficult for a third party to recognize the presence of the wireless communication tag inside. This helps reduce the likelihood of a third party plucking out the wireless communication tag inside.

The above-described method for manufacturing a 3D-modeled object includes: a process (a) of, after starting the stacking of layers of a modeling material, suspending the stacking for a while to feed a wireless communication tag to a predetermined position in the modeling material; and a process (b) of, after feeding the wireless communication tag, restarting the stacking of the modeling material to continue to stack the modeling material until the modeling of the 3D-modeled object is completed so that the wireless communication tag is embedded inside the 3D-modeled object.

With this manufacturing method, in the middle of the stacking of the modeling material, the wireless communication tag is fed to the predetermined position in the modeling material, and thereby the wireless communication tag is embedded inside the 3D-modeled object, which as a whole is formed by stacking the modeling material. This provides effects similar to those provided by the manufacturing apparatus configured as described above.

In the manufacturing apparatus described above, the controller may calculate an embedding position at which to embed the wireless communication tag inside the 3D-modeled object based on the 3D shape data of the 3D-modeled object and the shape data of the wireless communication tag, and may have the wireless communication tag fed in the middle of the stacking of the modeling material such that the wireless communication tag is embedded at the calculated embedding position.

The manufacturing method described above may further include a process (c) of calculating an embedding position in which to embed the wireless communication tag inside the 3D-modeled object based on the 3D shape data of the 3D-modeled object and the shape data of the wireless communication tag, and, in the processes (a) and (b), the stacking of the modeling material and the feeding of the wireless communication tag may be controlled such that the wireless communication tag is embedded in the embedding position calculated in the process (c).

The position at which to embed the wireless communication tag is calculated based on the shape (size) of the 3D-modeled object and the shape (size) of the wireless communication tag. Thus, it is possible to embed the wireless communication tag at an appropriate position at which the wireless communication tag does not protrude out of the 3D-modeled object.

The manufacturing apparatus described above may further include a storage that stores shape data for a plurality of wireless communication tags. The controller may select a wireless communication tag with a shape that can be embedded referring to the storage based on the 3D shape data of the 3D-modeled object, and may calculate the embedding position for the selected wireless communication tag.

In the manufacturing method described above, in the process (c), shape data for a plurality of wireless communication tags may be stored in a storage, and based on the 3D shape data of the 3D-modeled object, a wireless communication tag with a shape that can be embedded may be selected referring to the storage so that the embedding position is calculated for the selected wireless communication tag.

In a case where shape data for a plurality of wireless communication tags is stored, based on the shape data of the 3D-modeled object, a wireless communication tag with a shape that can be embedded is selected referring to the storage, and a position at which to embed it is calculated. Thus, it is possible to embed a wireless communication tag with an appropriate shape at a position inside the 3D-modeled object according to the shape of the 3D-modeled object.

In the manufacturing apparatus described above, the controller may merge layer data obtained from 3D shape data of the 3D-modeled object with data of a space for embedding the wireless communication tag inside the 3D-modeled object, thereby to re-construct layer-by-layer data of the 3D-modeled object, and the modeler may stack layers of the modeling material based on the re-constructed layer-by-layer data.

The manufacturing method described above may further include a process (d) of merging layer data obtained from 3D shape data of the 3D-modeled object with data of a space for embedding the wireless communication tag inside the 3D-modeled object, thereby to re-construct layer-by-layer data of the 3D-modeled object, and in the processes (a) and (b), layers of the modeling material may be stacked based on the re-constructed layer-by-layer data.

By stacking the modeling material based on the reconstructed layer-by-layer data for the modeling material, it is possible, while securing a space in which to embed the wireless communication tag, to stack the modeling material to manufacture the 3D-modeled object.

In the manufacturing apparatus described above, the controller may determine the feed timing with which to feed the wireless communication tag to the predetermined position based on the layer-by-layer data, and the tag feeder may feed the wireless communication tag with the feed timing determined by the controller.

The manufacturing method described above may further include a process (e) of determining the feed timing with which to feed the wireless communication tag to the predetermined position based on the layer-by-layer data, so that, in the process (a), the wireless communication tag is fed with the feed timing determined in the process (e).

In that case, for example, it is possible to set the timing with which to feed the wireless communication tag after the start until the end of the formation of the space for embedding the wireless communication tag through the stacking of the modeling material based on the layer-by-layer data. In this way, it is possible to feed the wireless communication tag to the embedding position with that feed timing to embed it there.

In the manufacturing apparatus described above, the controller may take, as the feed timing, the time point at which a recess with a depth corresponding to the thickness of the wireless communication tag is formed by the stacking of the modeling material.

In the manufacturing method described above, in the process (e), as the feed timing, the time point at which a recess with a depth corresponding to the thickness of the wireless communication tag is formed by the stacking of the modeling material may be taken as the feed timing.

In that case, it is possible, after a recess with a depth corresponding to the thickness of the wireless communication tag is formed by the stacking of the modeling material, to feed the wireless communication tag into the recess to embed it there. It is thus possible to confirm that the wireless communication tag has been embedded in the recess.

The manufacturing apparatus described above may further include a receiver that receives the 3D shape data of the 3D-modeled object. The manufacturing method described above may further include a process (f) of receiving the 3D shape data of the 3D-modeled object.

In that case, it is possible to perform processes that uses the 3D data of the 3D-modeled object, namely the calculation of the embedding position of the wireless communication tag, the selection of a wireless communication tag with a shape that can be embedded, and the creation of layer-by-layer data.

In the manufacturing apparatus described above, the modeler may include an ink ejector that ejects ink as the modeling material and an ink feeder that feeds the ink to the ink ejector. In the manufacturing method described above, in the processes (a) and (b), the layers of the modeling material may be stacked by use of ink as the modeling material.

In that case, it is possible to obtain the above-mentioned effects in a case where a 3D-modeled object is manufactured by an ink-jet process in particular out of different additive manufacturing processes.

In the above-described apparatus and method for manufacturing a 3D-modeled object, “the wireless communication tag being embedded inside the 3D-modeled object” means that the wireless communication tag is embedded inside the 3D-modeled object such that the wireless communication tag is completely invisible from outside; it is thus assumed that a configuration where the wireless communication tag is embedded inside but is visible from outside does not count as “the wireless communication tag being embedded inside the 3D-modeled object”. Accordingly, to implement a configuration where “the wireless communication tag is embedded inside the 3D-modeled object”, it is preferable to perform modeling by use of an opaque material (e.g., colored ink), or to perform modeling by use of a transparent material and an opaque material as the modeling material such that the wireless communication tag is covered by the transparent material and that the transparent material is covered by the opaque material. Here, the transparent material and the opaque material may be applied in the reverse order.

### INDUSTRIAL APPLICABILITY

A manufacturing apparatus and a manufacturing method according to the present invention find applications in the manufacture of 3D-modeled objects by use of an additive manufacturing process.

### LIST OF REFERENCE SIGNS

1 manufacturing apparatus

11 3D data receiver

12 controller

13 storage

20 modeling block (modeler)

21a modeling material ejector (ink ejector)

21b modeling material feeder (ink feeder)

30 tag feeding block (tag feeder)

1. An apparatus for manufacturing a 3D-modeled object, comprising:
a modeler that models a 3D object by stacking layers of a modeling material one over another;
a tag feeder that feeds a wireless communication tag to a predetermined position; and
a controller that controls stacking of the modeling material by the modeler and feeding of the wireless communication tag by the tag feeder,
wherein
the controller makes the tag feeder feed the wireless communication tag to the predetermined position in the modeling material in a middle of the stacking of the modeling material by the modeler such that the wireless communication tag is embedded inside the 3D-modeled object formed of the stacked layers of the modeling material.

2. The apparatus of claim 1, wherein
the controller calculates an embedding position at which to embed the wireless communication tag inside the 3D-modeled object based on 3D shape data of the 3D-modeled object and shape data of the wireless communication tag, and
the controller has the wireless communication tag fed in a middle of the stacking of the modeling material such that the wireless communication tag is embedded at the calculated embedding position.

3. The apparatus of claim 2, further comprising:
a storage that stores shape data for a plurality of wireless communication tags,
wherein
the controller
selects a wireless communication tag with a shape that can be embedded referring to the storage based on the 3D shape data of the 3D-modeled object, and calculates the embedding position for the selected wireless communication tag.

4. The apparatus of claim 1, wherein
the controller merges layer data obtained from 3D shape data of the 3D-modeled object with data of a space for embedding the wireless communication tag inside the 3D-modeled object, thereby to re-construct layer-by-layer data of the 3D-modeled object, and
the modeler stacks layers of the modeling material based on the re-constructed layer-by-layer data.

5. The apparatus of claim 4, wherein
the controller determines feed timing with which to feed the wireless communication tag to the predetermined position based on the layer-by-layer data, and
the tag feeder feeds the wireless communication tag with the feed timing determined by the controller.

6. The apparatus of claim 5, wherein
the controller takes, as the feed timing, a time point at which a recess with a depth corresponding to a thickness of the wireless communication tag is formed by stacking of the modeling material.

7. The apparatus of claim 2, further comprising:
a receiver that receives the 3D shape data of the 3D-modeled object.

8. The apparatus of claim 1, wherein the modeler includes:
an ink ejector that ejects ink as the modeling material; and
an ink feeder that feeds the ink to the ink ejector.

9. A method for manufacturing a 3D-modeled object, comprising:
a process (a) of, after starting stacking of layers of a modeling material, suspending the stacking for a while to feed a wireless communication tag to a predetermined position in the modeling material; and
a process (b) of, after feeding the wireless communication tag, restarting the stacking of the modeling material to continue to stack the modeling material until modeling of the 3D-modeled object is completed so that the wireless communication tag is embedded inside the 3D-modeled object.

10. The method of claim 9, further comprising:
a process (c) of calculating an embedding position in which to embed the wireless communication tag inside the 3D-modeled object based on 3D shape data of the 3D-modeled object and shape data of the wireless communication tag,
wherein, in the processes (a) and (b), stacking of the modeling material and feeding of the wireless communication tag are controlled such that the wireless communication tag is embedded in the embedding position calculated in the process (c).

11. The method of claim 10, wherein
in the process (c), shape data for a plurality of wireless communication tags is stored in a storage, and based on the 3D shape data of the 3D-modeled object, a wireless communication tag with a shape that can be embedded is selected referring to the storage so that the embedding position is calculated for the selected wireless communication tag.

12. The method of claim 9, further comprising:
a process (d) of merging layer data obtained from 3D shape data of the 3D-modeled object with data of a space for embedding the wireless communication tag inside the 3D-modeled object, thereby to re-construct layer-by-layer data of the 3D-modeled object,
wherein, in the processes (a) and (b), layers of the modeling material are stacked based on the re-constructed layer-by-layer data.

13. The method of claim 12, further comprising:
a process (e) of determining feed timing with which to feed the wireless communication tag to the predetermined position based on the layer-by-layer data,
wherein, in the process (a), the wireless communication tag is fed with the feed timing determined in the process (e).

14. The method of claim 13, wherein
in the process (e), a time point at which a recess with a depth corresponding to a thickness of the wireless communication tag is formed by stacking of the modeling material is taken as the feed timing.

15. The method of claim 10, further comprising:
a process (f) of receiving the 3D shape data of the 3D-modeled object.

16. The method of claim 9, wherein
in the processes (a) and (b), the layers of the modeling material are stacked by use of ink as the modeling material.

17. The apparatus of claim 5, wherein
the controller takes, as the feed timing, a time point before a time point of completion of formation of a recess with a depth corresponding to a thickness of the wireless communication tag by stacking of the modeling material.

18. The apparatus of claim 5, wherein
the controller takes, as the feed timing, a time point of starting of formation of a recess with a depth corresponding to a thickness of the wireless communication tag by stacking of the modeling material.

19. The method of claim 13, wherein
in the process (e), a time point before a time point of completion of formation of a recess with a depth corresponding to a thickness of the wireless communication tag by stacking of the modeling material is taken as the feed timing.

20. The method of claim 13, wherein
in the process (e), a time point of starting of formation of a recess with a depth corresponding to a thickness of the wireless communication tag by stacking of the modeling material is taken as the feed timing.
